(19) United States
(12) Patent Application Publication
(10) Pub. No.: US 2003/0225668 A1
(43) Pub. Date: Dec. 4, 2003

(54) System and method of acquiring traffic data

(75) Inventors: Yukio Goto, Tokyo (JP); Ichiro Masaki, Boxborough, MA (US)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/084,941

(22) Filed: Mar. 1, 2002

(51) Int. Cl. G06F 17/60

(52) U.S. Cl. 705/37

(57) ABSTRACT

A system for negotiating acquisition of telematic data from at least one vehicle traveling along a traffic route and collecting telematic data. A system node provides a first polling signal including a first purchase offer. The probe detector responds to the first polling signal by comparing the first purchase offer to a selling price. If the first purchase offer at least meets the selling price, the probe detector transmits an availability signal including an assent parameter agreeing to the sale to the system node in response to the polling signal. If the system node accepts the availability signal, it transmits a release signal, and the telematic data is transmitted from the probe detector on the vehicle to the system node. The system node and probe detector may negotiate the price through multiple polling signals before release of the telematic data. The telematic data includes information that is processed by the system node, possibly in combination with a telematic base, to produce traffic condition information and predictions of future traffic conditions. The traffic information is sold to the vehicle with the probe detector and other users, sometimes in exchange for the telematic data.

### FIELD OF THE INVENTION

The present invention relates to the determination of vehicle traffic patterns, and, more particularly, to a system and method of negotiating for the exchange of telematic data between traveling vehicles and at least one system node for determining present traffic patterns and predicting future traffic patterns.

### BACKGROUND OF THE INVENTION

Roadway networks exist worldwide for facilitating the organized movement of motor vehicles. Typical roadway networks include rural roads, city streets, freeways, highways and the like. Often times, the major or preferred arteries of roadway networks, such as those traversing commercial districts and metropolitan areas become congested. Congestion is likely experienced during instances of intense usage, during inclement weather, and during periods of construction and accident obstruction. In an effort to alleviate such congestion, there have been developed a variety of traffic information gathering control technologies.

One information gathering and disseminating technology which is commonplace in most metropolitan areas is traffic reporting. Commuters traveling in a known congested network area, particularly during a time of high usage, such as the hours immediately before or after work hours, access traffic reports in an attempt to estimate a likely travel delay or to determine a route which may avoid a travel delay. The traffic report may be provided to individual commuters via electronic roadway billboards or variable message signs (VMS), radio broadcast, or through an automotive concierge service. The reports typically originate based upon visual observation via an aerial survey (i.e., helicopter) of roadway areas or through video images of cameras stationed along the roadway network and supplied to a reporting center.

Additionally, new roadway network construction increasingly employs more recently developed traffic management technologies. For example, many new roadways include high occupancy vehicle HOV lanes to encourage car-pooling in many metropolitan areas for reducing the number of vehicles on the roadway. Another recent traffic management technology is the roadway sensor or “point detector”. The point detector is typically a loop detector buried in the surface of a roadway to detect the volume of vehicles passing a known point. The loop detector is able to detect vehicle speed, vehicle numbers, and the volume of vehicles traveling along a series of point detectors. This data may then be utilized by traffic reporting services to provide traffic reports or to control signaling devices such as stop-lights to manage the flow of traffic between arteries more efficiently. However, such technologies are cost prohibitive in that they require alterations to the roadway surface. Moreover, those passive technologies are of limited use in dynamically forecasting traffic patterns. Therefore, alternative technologies are increasingly sought.

More recently, there has been an increased interest in the collection of “telematic” data for use not only in traffic reporting applications but for traffic forecasting. Telematic data is defined as data created by the combination of telecommunications and information processing capabilities of a properly equipped vehicle, such as an automobile.

For example, telematic data may include the intended destination of the automobile, the intended route for bringing the automobile to the destination, and any re-routing decided upon by the commuter in response to encountered traffic. With this object in mind, it is known that a cellular telephone communication can be resolved to a specific geographic location by triangulating the signal received at local cellular telephone receiving stations (i.e., cell towers). Indeed, new standards mandated by the Wireless Communication and Public Safety Act which require a cellular telephone to relay its geographic location (i.e., automatic location identification, ALI). Similarly, a global positioning system, GPS, receiver in a vehicle may be used for identifying the vehicle location. However, usage of such data in identifying a particular vehicle is a serious concern among drivers as it necessarily compromises privacy.

Accordingly, there is a need for a telematic system which provides for the negotiated exchange of telematic data from a commuter so that commuter privacy is protected and telematic data is provided only upon negotiated terms for use by a telematic data exchange system.

### SUMMARY OF THE INVENTION

The present invention provides a system for negotiating acquisition of telematic data originated from a vehicle traveling along a traffic route. A node provides a first polling signal including a first offer. At least one probe detector on the vehicle compares a desired selling price for determining whether to agree to the first offer. The probe detector transmits an availability signal including an assent to the system node in response to the polling signal if the first offer is at least equal to the desired selling price.

In a further aspect of the invention, the system node provides a release signal to access the assent and receive telematic data from the vehicle or a second polling signal changing the first offer in response to the availability signal. Thus, in an important aspect of the invention, the system node negotiates purchase of the telematic data at the lowest price.

In another aspect of the invention, telematic data is traffic information that is used to determine current traffic conditions and to forecast future traffic conditions.

In a further aspect of the invention, the system includes a plurality of system nodes and probe detectors for buying and selling telematic data at a negotiated price and redistributing the telematic data to vehicles with probe detectors and to other vehicles to reduce traffic congestion.

In still another aspect of the invention, the release signal of the system node includes a credit to the probe detector for use by the probe detector for purchasing traffic data from the system, or, providing confirmation of the delivery of a credit to a secondary account specified by a user of the probe detector.

### BRIEF DESCRIPTION OF THE DRAWINGS

These and other features, aspects, and advantages of the present invention will become more fully apparent from the following description, appended claims, and accompanying drawings in which:

FIG. 1 is a plan view of an exemplary telematic data exchange system in accordance with the present invention;

FIG. 2. is a velocity versus location graph showing an estimate of traffic speed as it relates to telematic data of a traveling vehicle speed;

FIG. 3 is a velocity versus distance graph showing a characteristic curve indicative of traffic conditions;

FIG. 4 is a graph showing predictive traffic information based on telematic data exchange in accordance with the present invention;

FIG. 5 is a block diagram showing the transmission of content to an exemplary customer interface in accordance with the present invention;

FIG. 6 is a flow chart of an exemplary user registration procedure in accordance with the present invention; and

FIG. 7 is a flow chart of an exemplary negotiation procedure in accordance with the present invention.

### DETAILED DESCRIPTION

Certain terminology used in the following description is for convenience only and is not limiting. The term “point detector” as used herein is generally defined as referring to an electronic traffic detection sensor employed in a road surface or in the vicinity of a road surface, such as an electromagnetic loop detector. However the present invention embraces other point detection sensing locations as well as types of sensors, such as optical, ultrasonic, heat, and pressure transducers. The term “probe detector” as used herein is generally defined as a transponder device. The transponder functionality may be integrated with the operation of a cellular telephone, a global positioning system (GPS) transceiver or the like, or be performed by a dedicated device of a vehicle. Similarly, probe detector data may be obtained directly from a Mobile Telephone Switching Office (MTSO) where the probe detector is a cellular phone. The term “conventional traffic data” as used herein is generally defined as traffic data supplied to the present system from point detector devices or similarly available data useful in forecasting traffic. These devices are usually operated by the public agencies (i.e., a department of transportation, highway management authorities, or police). The term “service provider” as used herein is generally defined as an entity which cooperates with the system to exchange services for credit earned by users of the system.

The present invention provides a system for negotiating a price for the exchange of telematic data between commuters using a “known” or previously identified traffic route and a telematic base. As described above, telematic data is defined as data created by the combination of telecommunications and information processing capabilities of a vehicle, such as an automobile. The system in accordance with the present invention negotiates with cooperating and properly equipped vehicles to exchange telematic data in accordance with a “market value” or price as determined by the system. The price may be negotiated in relation to the quality of the information provided, such as demand based on the time of day and route of interest. The price may also be negotiated based upon supply, i.e., the number of vehicles offering to supply telematic data. The telematic data gathered in the telematic base enables the telematic system to estimate the current traffic conditions and predict the future traffic conditions. The system may optionally incorporate conventional traffic data of point detectors to supplement the telematic determining and predicting traffic conditions. The determinations and predictions may be sold by the system to vehicles that do not supply telematic data and to vehicles that supply telematic data and are given purchase credits from the data supplied.

The telematic data may include further demographic information, such as user information, driving habits, driving history, vehicle make, model, and component status. The system determines the telematic data to request and includes an offer price in a polling signal sent from at least one system node or telematic base to probe detectors (or MTSO where cellular telephones serve as probe detectors) of vehicles within the range of the base station equipped for responding and in traffic. The probe detector employs a user profile in which a “selling price” for selling telematic data is included. Where the selling price is equal to or greater than the first “offer price”, the probe detector transmits an availability signal including an assent parameter. In response, the telematic base can choose to have the telematic data released to it from the probe detector by transmitting a release signal to the probe detector in response to the availability signal, or may make a second offer via the transmission of a second polling signal including a second offer price to the probe detector. Where the probe detector is a cellular telephone, the release signal may be provided to the MTSO for accessing telematic data from the home location register (HLR) of the cellular telephone. If the second offer price is still equal to or greater than the selling price, the availability signal is again transmitted. The second offer price may be lower than the first offer price if availability signals are received by the base station from more probe detectors than a threshold number, providing sufficient telematic data for determination of traffic conditions. If fewer availability signals are received by the base station than the threshold number in response to the first offer price, the second offer price may be higher than the first offer price. This negotiation may continue until the threshold number of availability signals are received or a maximum offer price is reached. The threshold number and maximum offer price may vary with time and location.

If traffic conditions are relatively stable, such as during late night or weekend hours, the telematic base may not collect any telematic data from probe detectors. Thus, the offer price of telematic data is relatively low when traffic is stable. Conversely, if traffic patterns are changing dynamically, as in rush hour or like commuting times, the thematic base must collect enough telematic data to determine present traffic conditions and to forecast traffic patterns. Accordingly, the price for telematic data purchased from probe detectors should be relatively higher during periods of intense roadway usage, provided the number of probe detectors available to supply telematic data is not excessive.

When telematic data is released by a probe detector to the telematic base, the telematic base provides a credit signal including a credit to the corresponding probe detector for completing the purchase of the telematic data, or, alternatively, credits a second user account specified in the user profile. The credit parameter transmitted to the probe detector can then be stored for later use or immediately utilized by the probe detector to purchase the traffic forecast or like ancillary services from the system in accordance with user profile settings. When the user of the probe detector desires the traffic forecast, the user transmits the credit stored in a memory of the probe detector device to the telematic base. In response, the telematic base transmits traffic determination and/or prediction to the probe detector, applying the credit, if there is one, or charging the account. Likewise, other users of the system that are not probe detectors may request traffic determinations and forecasts. Since these users lack credits for supplying telematic data, their accounts, e.g., established accounts with the system or credit cards, are charged for the traffic information supplied.

When the user does not desire direct content transmission, or does not employ a probe detector capable of adequately providing the content to the user, the user may elect a secondary account credit. For example, the content credit may be credited to a second account of the user for use in purchasing a service of a cooperating service provider, such as an automated toll account. A service provider having access to the second account can then be contacted by the user for spending credits. In this embodiment, the service provider transmits a debit signal to the telematic system for adjusting the available credit balance of the user. The corresponding debit would then be provided to the probe detector through the telematic service provider.

Similarly, the user may provide the credit stored in the probe detector to an electronic device such as a vending machine via a personal identification number (PIN) such as a cellular telephone number.

System Components

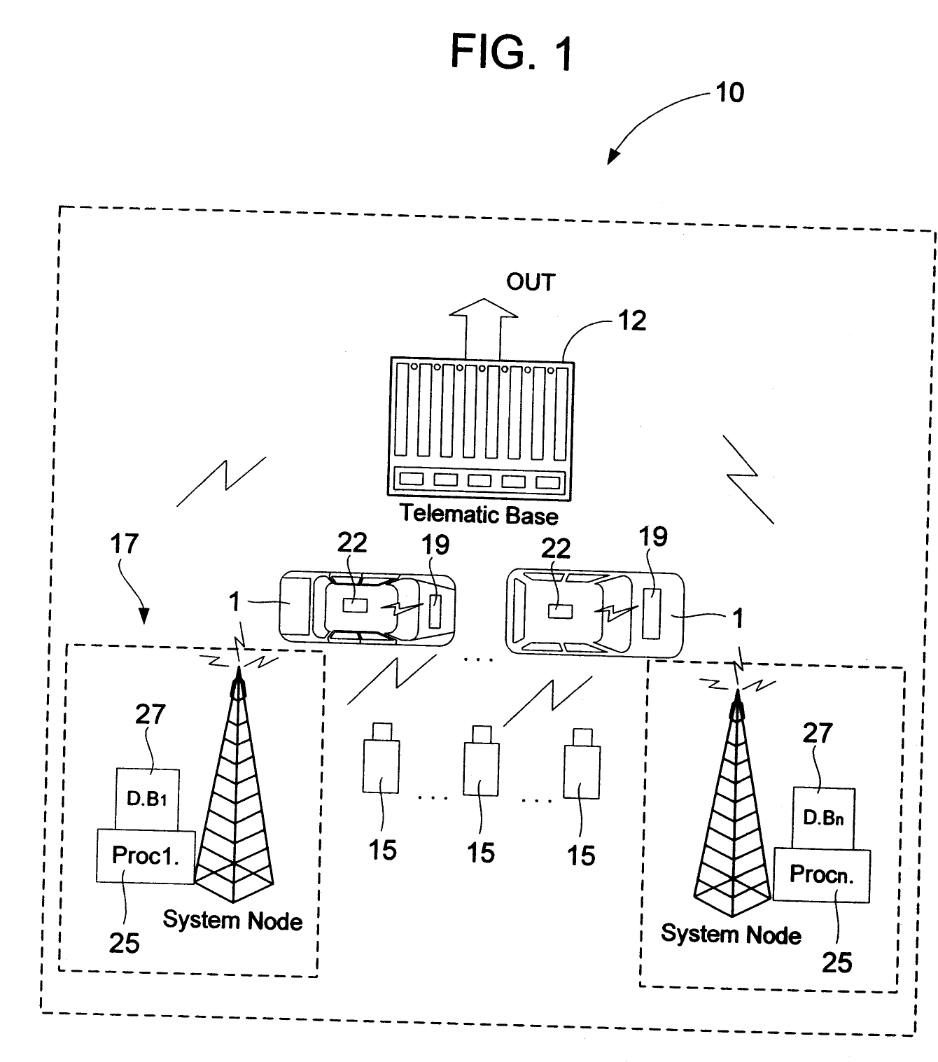

In the drawings, the same reference numerals are used for designating the same elements throughout the several figures. Referring now more particularly to FIG. 1, a block diagram of an exemplary system 10 for negotiating the exchange of telematic data is shown. The system 10 includes vehicles 1, a telematic base 12, probe detectors 22, optional enabling devices 19, system nodes 17, and point detectors 15.

In an exemplary embodiment, the telematic base 12 exchanges signals with the system nodes 17 to provide traffic forecasting data and/or content credit data to participating probe detectors 22, determine offer parameters, and generally initiate and manage the negotiation of telematic data exchange (e.g., polling signals and responses). While the telematic base 12 described here as independent of system nodes 17, the functions of the telematic base 12 may be integrated with each system node 17 to provide separate traffic forecasting sectors, i.e., regions, with respect to each system node 17, or to designate a master system node. The telematic base 12 employs hardware components, such as a memory, data processor, and input/output circuitry, for traffic determination and forecasting, as well as the management of system transmissions and operations. In the exemplary embodiment, an artificial intelligence module may be used for “learning” traffic patterns in relation to conventional traffic data and telematic data. An exemplary artificial intelligence module may employ neural network circuitry and/or fuzzy logic design for adapting the traffic forecast to system behavior.

In embodiments employing independently functioning telematic bases 12, the telematic bases 12 may transmit and receive signals from system nodes 17 via wireless technology. For example, where the probe detectors 22 are cellular telephones, cellular communication technology may be utilized. A variety of analog and digital wireless transmission schemes are equally applicable, such as radio frequency (RF) and personal communication system (PCS) technology. Further, communications of the telematic base may be encrypted in accordance with known encryption technologies to ensure secure transmission of telematic data. In general, each telematic base 12 controls several system nodes 17. However, each system node 17 may include a database and processor, as discussed below for semi-autonomous operation.

The telematic base 12 may also communicate with an MTSO for accessing telematic data of the HLR in addition to, or, alternatively, with respect to, the probe detector 22. This arrangement would provide telematic data stored by the MTSO such as that provided in compliance with the Wireless Communication and Public Safety Act.

Upon the release of telematic data from a probe detector 22 to the telematic base 12, the telematic base 12 transmits a corresponding credit signal including a credit parameter to the corresponding probe detector 22 for completing the purchase of the telematic data, or, alternatively, credits a secondary user account specified in a user profile of the corresponding probe detector 22. The terminal OUT of telematic base 12 designates the exchange of credit parameters with a secondary account of a service provider via land-based and/or wireless means. When the credit parameter is transmitted to the probe detector 22 directly, the content credit may then be utilized by the probe detector 22 to purchase the traffic forecast or determination through a telematic base 12. Alternatively, the user may purchase ancillary services in accordance with the terms of the secondary account as dictated by the terms of a service provider having access to the secondary account. For example, the content credit may be credited to a second account of the user for use in purchasing a service of a second cooperating service provider, such as an automated toll account, satellite radio subscription, internet access service, stock exchange, or news reporting service.

The user of the probe detector 22 may be assigned a personal identification number (PIN) for referencing a credit amount stored in the probe detector for application in other electronic transactions such as to defray the cost of an automated teller surcharge (ATM), purchase postage stamps, or for donating a stored credit amount to a charitable organization. In the exemplary embodiment, a cellular telephone number of the probe detector 22 functions as the PIN, in addition to a user specified security number. In such case, the second participating service provider would transmit a debit signal to the telematic base 12 for services provided to the user for adjusting the available credit balance of the user. The corresponding debit would then be provided to the probe detector 22 by way of the telematic base 12. Further, the user may provide the content credit stored in the probe detector 22 to an electronic device of the vehicle having more desirable feedback capabilities for providing the traffic forecast and determination data (i.e., audio and/or video) via the PIN. The electronic device would then transmit the credit parameter to the telematic base (or closest system node 17) for accessing the traffic data.

The exemplary system nodes 17 provide an intermediate destination for signals of probe detectors 22 and the telematic base 12. The exemplary system nodes 17 may be co-located with cellular telephone towers using the cellular tower transmission range and access to cellular phones signaling devices within that transmission range. In an exemplary embodiment, each of the system nodes 17 includes a database 27 and a processor 25. The databases 27 serve as a repository for telematic data and point detector data (where utilized) pertaining to the region covered of the system node 17 (e.g., transmission range of a cellular telephone tower). The processor 25 is provided to control the relay of signals between probe detectors 22 and the telematic base 12 as well as to coordinate the use of the transmission tower for signaling the probe detectors 22. In embodiments where the telematic base 12 is integrated with a system node 17, the processor 25 may be omitted in favor of the processing capacity of the telematic base 12.

The probe detectors 22 of the exemplary embodiment collect telematic data pertaining to the vehicle route, store history data of vehicle travel, and may store demographic data of the user. Some of this data may be shared with or stored in the HLR of an MTSO as discussed above, when the exemplary probe detectors 22 are cellular telephones. The probe detectors 22 also store the user profile input by the user via an interface such as an alpha-numeric keypad. The user profile includes a desired parameter, demographic data, and sets user options for telematic data exchange. Exemplary demographic data include such information as name, age, sex, vehicle manufacture, model, year of manufacture, mileage, and traveling history (i.e., regular commuter, fleet car, etc). The desired parameter indicates a price at which the user is willing to sell telematic data to the telematic base 12, which portions of available data the user is willing to sell, and credit delivery options (i.e., direct delivery or secondary account). For example, a user may not wish to sell his driving history (i.e., where he has been in the last few weeks), but may be willing to sell his demographic data, or present travel route. Moreover, the user may select that only data shared with an MTSO is to be released by the MTSO upon receiving permission or “confirmation” from the probe detector via an assent parameter of an availability signal. A user may specify these options in the profile and store them in a memory of the probe detector 22. This information is then relayed along with the availability signal of the probe detector 22. The probe detector 22, while described in terms of a portable cellular telephone, may be a dedicated telematic device fixedly secured to the vehicle. The described functions may be integrated with a GPS receiver. The GPS receiver can track location and, when location information is combined with time, can provide route and speed records that are used with other data of the probe detector to produce the telematic data. By way of further example, rental cars, police cars, taxis, and public service vehicles may more effectively employ a dedicated probe detection device 22. These vehicles may function as probe detectors that can exchange telematic data at all times in exchange for traffic data from the telematic base 12. Where the vehicle is a rental car, to ensure privacy, customers would have the option of disabling the exchange of telematic data.

An exemplary probe detector 22 records and stores telematic data at a regular interval as shown in Table 1. This data may be logged internally in the probe detector 22 and/or stored by an MTSO.

TABLE 1

<time>2001:6:15:0:11:55</time>
<lat>140.433995</lat>
<lon>36.460051</lon>
<alt>120.05200</alt>
<speed>48.520816</speed>
<dir>-O.049995</dir>
<mileage>2.5 88039</mileage>
<destination><lat>147.423895</lat><lon>38.470061</lon></dest>
<linkTravelTime>
<linkNo>1</linkNo><travelTime>93.00000</travelTime><time>
2001:6:15:0:07:27</time>
<linkNo>3</linkNo><travelTime>43.00000</travelTime><time>
2001:6:15:0:09:00</time>
<linkNo>9</linkNo><travelTime>15.00000</travelTime><time>
2001:6:15:0:09:43</time>
<linkNo>5</linkNo><travelTime>22.00000</travelTime><time>
2001:6:15:0:09:58</time>
<linkNo>8</linkNo><travelTime>43.0000</travelTime><time>
2001:6:15:0:10:20</time>
<linkNo>2</linkNo><travelTime>43.0000</travelTime><time>
2001:6:15:0:11:03</time>
<linkNo>7</linkNo><travelTime>3.00000</travelTime><time>
2001:6:15:0:11:48</time>
<linkNo>4</linkNo><travelTime>4.00000</travelTime><time>
2001:6:15:0:11:51</time>
</linkTravelTime>
<rain>NoRain</rain>
<radio>94.1 fm</radio>

The exemplary data set includes current vehicle condition, such as time, vehicle position (latitude, longitude, and direction), destination, speed, mileage, and status of the wipers, i.e., an indication of weather conditions. Furthermore, the data set includes travel history such as traveling time through a specific traffic route section or “link” with the time. The destination may be directly input by the user or determined by the telematic base 10 by historical data and time of day (i.e., work route) In an exemplary embodiment, the directional data (i.e., latitude, longitude, time, etc) is computed by the MTSO or by the probe detector 22. The timing data may be determined relative to point detectors, where such conventional traffic detectors are utilized, or by an internal time clock. Where vehicle data, such as wiper status and radio station tuned, are desired, the probe detector 22 has an interface for receiving these data items from the vehicle (i.e., a docking port), or, alternatively, receives the data periodically from an enabling device 19 that controls when the vehicle is enabled to act as a probe detector.

The telematic base 12 collects enough data to estimate traffic condition in the whole of a particular traffic network, e.g., an entire metropolitan area, and/or for sections of such a traffic network or a particular roadway.

When the telematic base 12 purchases the telematic data of probe detectors 22 after the described negotiation with the probe detector 22, the telematic data is saved to the memory 27 of a system node 17 or to a memory of the telematic base 12.

In the depicted embodiment, the enabling device 19 is optionally provided for the probe detectors 22 to enable the associate probe detector to receive signals from the system nodes 17. The enabling device “unlocks” the probe detector 22 of the corresponding vehicle for telematic data exchange only when the vehicle is in motion or a similar operating condition such as vehicle movement. In this way, the exemplary enabling device 19 may keep probe detectors from providing meaningless data to the telematic base 12 when a vehicle is stationary for prolonged periods, such as when parked or disabled. The enabling device 19 is located on the vehicle. The enabling device 19 may include a security code for unlocking a specific probe detector 22 (i.e., vehicle owner), or any probe detector 22. In an exemplary embodiment, the enabling device 19 transmits a wireless signal to the probe detectors 22. However, the enabling device may be hard wired to the probe detector 22 where a probe detector 22 is designed to rest in the docking port of a vehicle such as utilized by police for interfacing a laptop computer. The “unlock signal” of the exemplary embodiment is transmitted periodically along with vehicle component data signals, such as wiper status, radio tuning, and vehicle speed.

In an exemplary embodiment of the system, optional point detectors 15 provide conventional traffic data to the telematic base 12. The traffic data of point detectors 15 are connected to a local system node 17 in the vicinity of a respective point detector 15 (i.e., closest in geographical relation). The inclusion of conventionally obtained traffic data is not necessary to the present invention, but provides an added parameter for use in determining and predicting traffic by the telematic base 12.

General Negotiation

The negotiation process, previously generally described, is now described with reference to the embodiment of FIG. 1. The probe detector 22 determines if telematic data is to be released, i.e., “sold”, to the telematic base 12 at the offered price (offer parameter of poll signal). For example, if the desired parameter or “MIN-PRICE” of the probe detector 22 is lower than the offer price, the probe detector 22 offers to sell its telematic data in return for credit, credit to a secondary account, or the right to receive traffic information. If the probe detector 22 has a special contract with the telematic base 12 (e.g., fleet contract), this dealing can be done at a monthly or annual fee. In the exemplary embodiment, after the availability and release signals are exchanged, the telematic data, upon release, is transmitted to the telematic base 12 from the probe detector 22 or accessed by the telematic base 12 from an MTSO. The telematic base 12 determines traffic conditions in the route of interest based on the information provided by the probe detectors 22. This telematic data may be supplemented with data of point detectors 15.

Moreover, the telematic base 12 may provide a plurality of offer prices to the probe detector 22 to correspond to a plurality of desired parameters of the user. For example, the user may desire a different selling price for traveling history, as opposed to present data or demographic data. Alternatively, the telematic base 12 may decide the offer price for the telematic data based on the amount of time that can be saved by avoiding a congested route in favor of a less congested route. For example, if the user must travel for two hours through congested routes as opposed to one and one-half hours by way of less congested routes, the thirty minutes time saved to the user may be of particular value to commercial carriers who will pay more for that information. Therefore, under certain determined or forecast traffic conditions, the offer price may be increased.

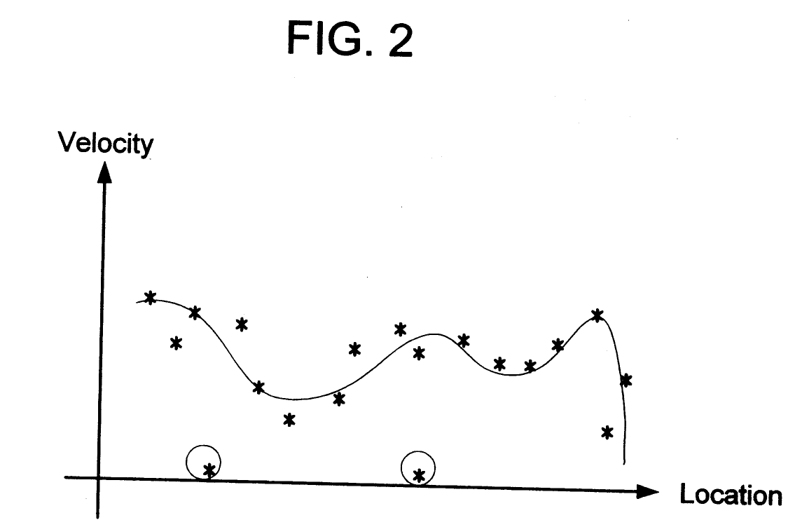

Referring now to FIG. 2, a velocity versus distance graph showing an estimate of traffic speed as it relates to telematic data of a traveling vehicle speed is shown. Thus, an estimated traffic speed at a predetermined route based on telematic data of a probe detector 22 is determined. FIG. 2 shows an exemplary relationship between speed and location of a probe detector 22 supplied by telematic data. Each asterisk designates the speed of a probe detector 22 (i.e., vehicle) on a velocity versus location graph. The curvature of the line illustrates changes in traffic conditions due to changes in speed (such as along a highway straight-away). The telematic base 12 may utilize a statistical method, such as regression analysis, for computation of an anomalous vehicle speed data or a vehicle speed different from the estimated speed may be omitted to control quality of the telematic data.

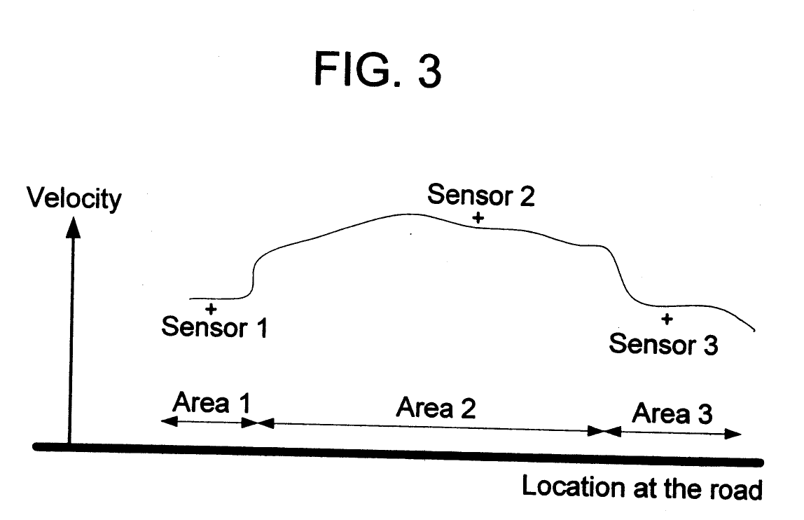

FIG. 3 is a graph of speed versus location for three different regions. The line designates the traffic speed estimated from the telematic data of the probe detectors 22. The cross designates actual traffic speed. In FIG. 3, the indicated traffic condition, i.e., speed, determined in area 2 is the speed at the point where the probe detector or “sensor 2 ” is located. Similarly, the traffic conditions, i.e., speeds, in areas 1 and 3 are likewise identical to the respective sensor data of sensors, i.e., probes, in those areas.

The exemplary telematic base 12 may predict future traffic conditions by integrating dynamically collected telematic data and conventional traffic data stored in a memory of the system 10 of FIG. 1 as roadway traffic patterns that are cyclical in nature. For example, daily patterns are morning and evening rush hours on weekdays. In addition, there may be weekly patterns, monthly patterns, and annual patterns. If the current time is t, the telematic base 12 detects traffic pattern X(t), based on time, date, and day, as traffic condition Y(t)(t≦=T) and predicts the future traffic condition Y(t), (t>T), as

$$Y ( t ) = {\int }_{0}^{t} [ Y ( τ ) - X ( τ ) ] ⅆ τ / T + X ( t ) , ( t > T ) .$$

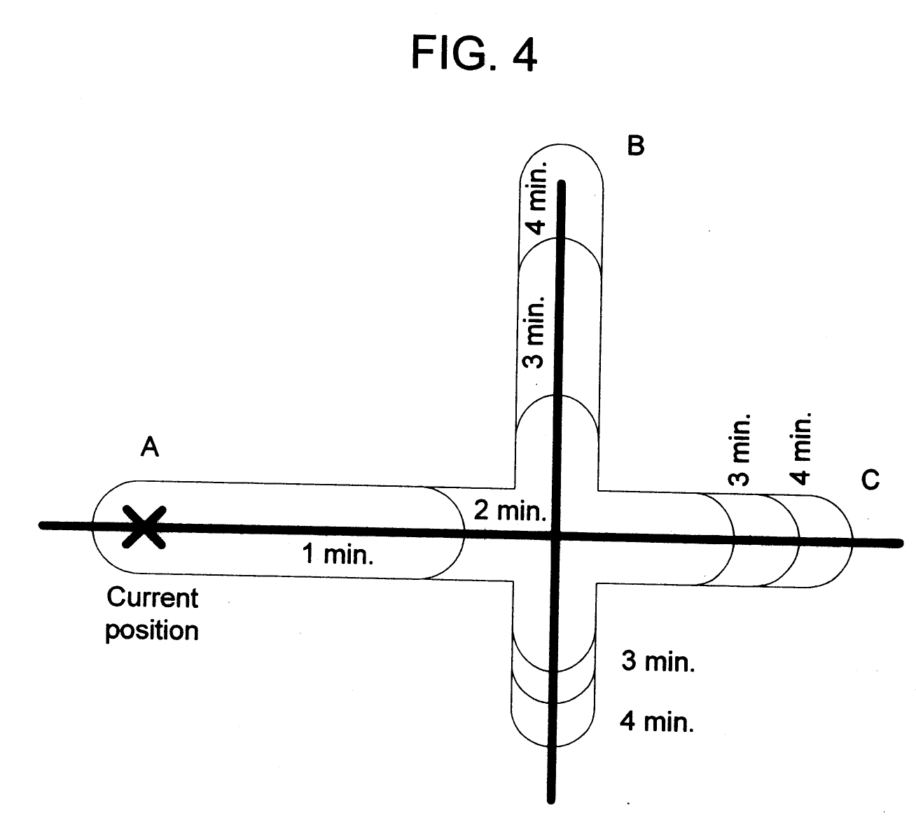

Referring now to FIG. 4, predictive traffic models employed by the telematic base 12, using telematic data and conventionally gathered traffic data, predict traffic flow and patterns. The result of one such prediction is shown in FIG. 4. The traffic flow contours of FIG. 4 represent the distance a driver may travel, based upon the determined congestion of traffic routes A, B, and C. From this forecast, a user may select a route to minimize delay in travel. The traffic forecast can be delivered through a variety of technologies, an exemplary technology being described below.

Direct Content Transfer To A Probe Detector

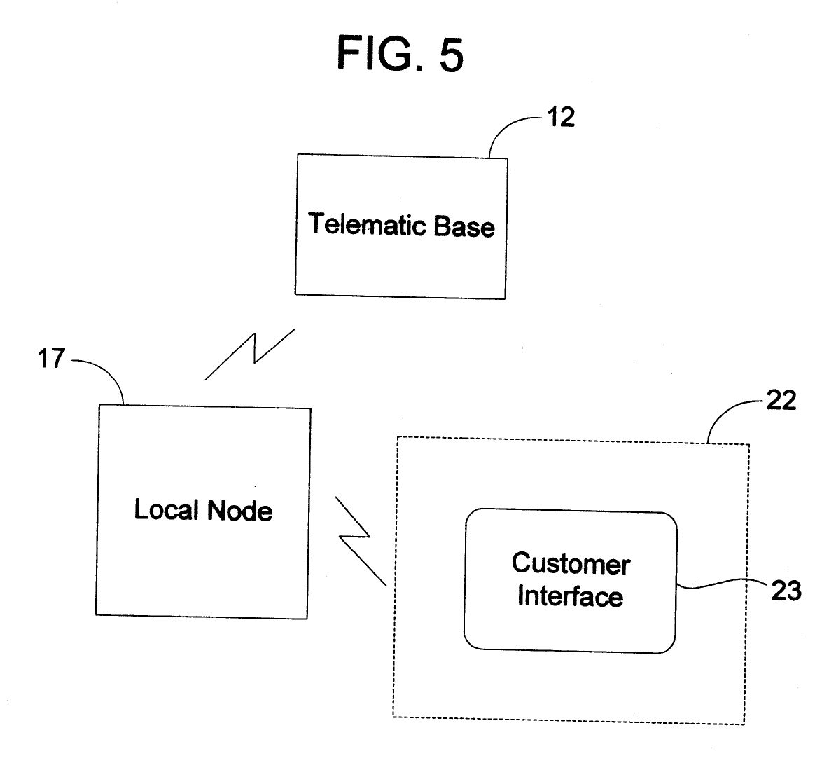

FIG. 5 is a block diagram of a probe detector 22 employing a customer interface 23 for receiving traffic information from the telematic base 12 in accordance with the present invention.

As described above, a user profile may specify a user preference for receiving payment from the telematic base 12. The user may desire a credit be delivered to the probe detector 22, a credit be delivered to a secondary account, and/or a credit for the subsequent delivery of traffic information to a customer interface 23 within the probe detector. Assuming the user has accumulated enough credit to purchase the traffic data from the telematic base 12 and has selected the reception of traffic data as a payment option, the telematic base 12 transmits traffic information to the customer interface 23. Respective probe detectors may exchange telematic data at a higher rate paid by the telematic base but a lower rate paid for collected and forecast data. One exemplary customer interface is the display portion of a cellular telephone. Alternatively, the user may specify delivery to a video display on an on-board navigation system, such as a GPS display device of the vehicle 1. The delivery of traffic information to an alternative display of the vehicle 1 may require the probe detector 22 to relay the traffic information via a wireless protocol. Alternatively, the user profile may provide instructions for delivering the content directly to the device having the desired display. As mentioned above the transmission of data from telematic base 12 to a probe detector 22 may be exchanged with system node 17 as an intermediary. The use of system node 17 is especially helpful where the delivery of the traffic information is via a cellular telephone channel.

In an exemplary embodiment, the traffic data may be provided to the user as a cellular transmission in the form of a computer generated audio message such as “ten minute delay U.S. highway 1, heavy volume between Main St. and Suburb St . . . . . U.S. highway 2, three minute delay between Main St. and Suburb St . . . . press 1 or say “yes” if you intend to detour.” Upon pressing “1 ” on a keypad or speaking “yes” via the probe detector 22, the user is notifying the telematic base of traffic volume corrections with respect to U.S. highway 1 (decrease) and (increase) U.S. highway 2. Alternatively, the audio may be broadcast to a specific frequency of a satellite radio, the subscription to which is provided based on user system credits. Similarly, the same report may be provided in visual form to a video display of the vehicle, prompting the user for intended detours before the display can be returned to its prior state. In this presentation, the user is presented with a map showing locations of delays, and the user is prompted to enter an intended path, and then, where applicable, a detour path. In this embodiment, the detour path is transmitted back to the telematic base 12 as a part of the original negotiation in order to provide predictive data.

In another exemplary embodiment, a general traffic information bulletin board may be provided to a user or between probe detectors free of charge. If the user wants current and/or predicted traffic information, the user may be encouraged to change his desired parameter settings by way of the bulletin board. The general bulletin board may show the present market value of telematic data by region. Respective probe detectors may exchange telematic data without charge or at a lower rate than paid to the telematic base because collected and forecast data is not available from another probe detector.

Exemplary System Methodology

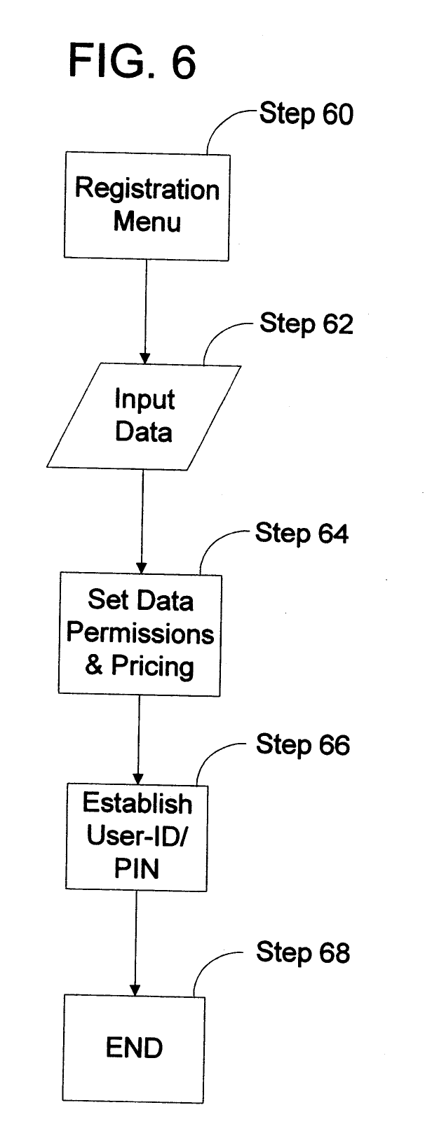

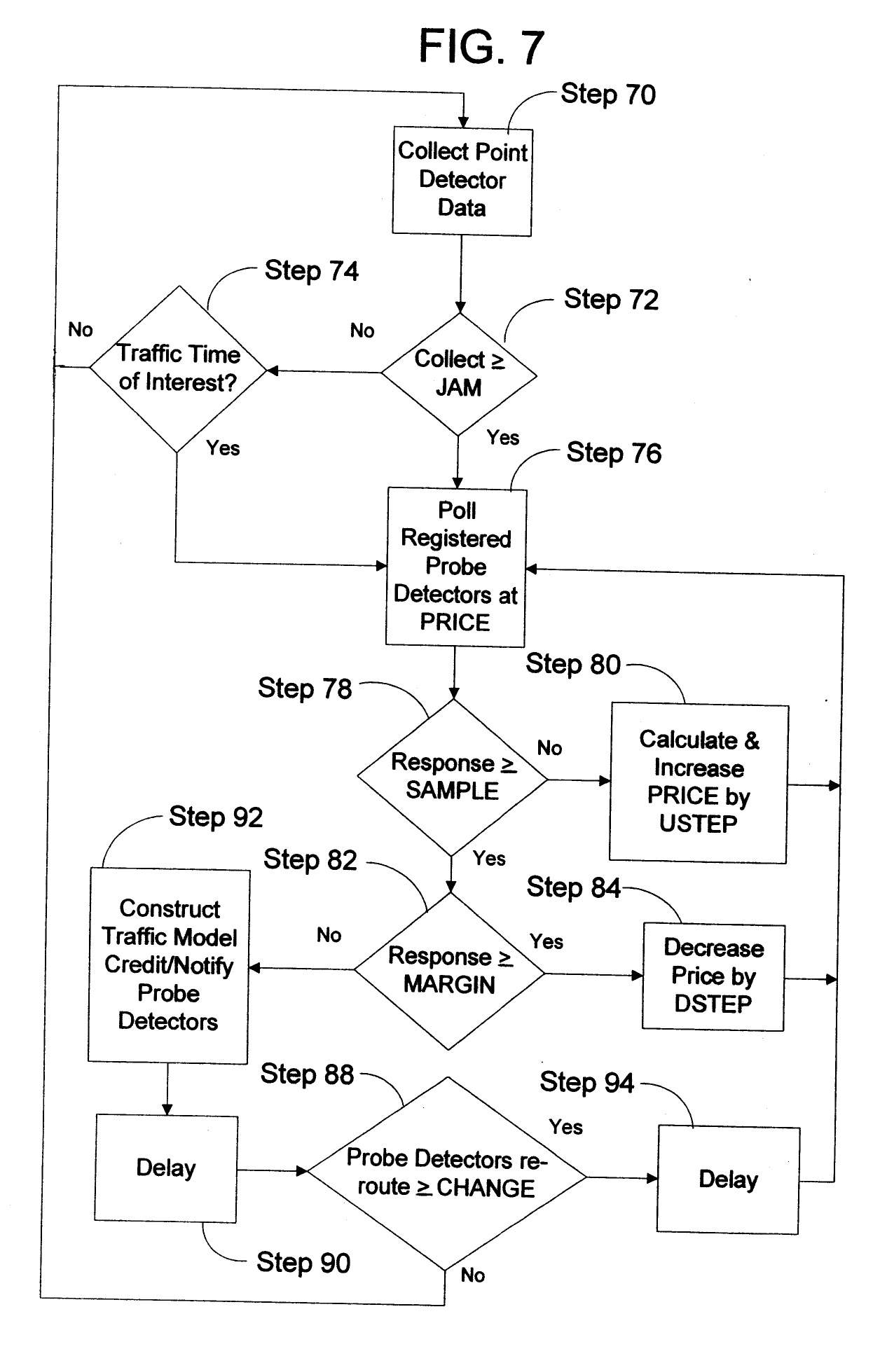

An exemplary method of initializing a user profile is shown in FIG. 6 and an exemplary negotiation method is shown in FIG. 7. Those skilled in the art will recognize that the methods may be practiced with additional or omitted steps without departing from the scope or spirit of the present invention.

FIG. 6 shows an exemplary method of initializing a user profile. At step 60, the user is presented with a registration menu. The registration menu may be a default menu which is presented upon powering of a device for the first time. For example, upon purchasing a cellular phone, the user must specify the settings in the registration menu prior to operating the device, such as that required by personal computing software set-up wizards. The user may choose to disable registration entirely if no telematic data exchange is desired. At step 62, the user inputs demographic data and specifies negotiation parameters and desired settings. At step 64, the user selects telematic data exchange permissions. In other words, the user sets desired pricing parameters and what information the user is willing to sell. At step 66, the user establishes a user-ID. In the exemplary embodiment, the user-ID is a PIN or cellular number, electronic security number (ESN), or number assignment module (NAM) specifically assigned to the user. This PIN data identifies the user, the transmission of which is expressed as an assent parameter. The PIN may also be used to access data from the MTSO where telematic data and the user profile is shared in compliance with the Wireless Communication and Public Safety Act. At step 68, the creation of the user profile is completed.

Referring now to FIG. 7, an exemplary flow diagram of the negotiation process for exchanging telematic data is shown. At step 70, the system 10 collects conventionally obtained traffic data, such as that of point detectors 15. Step 70 is optional to the collection of telematic data, but may be advantageous for detecting unexpected traffic jam conditions. At step 72, the point detection data is provided to the telematic base 12 and the data is compared to a parameter JAM. If the point detection data indicates a traffic jam, the process proceeds to step 76, otherwise the process proceeds to step 74. At step 74, the telematic base determines whether the present time is of general or special interest (i.e., rush hour). If it is not a time of special interest, the process loops to step 70; if the telematic base 12 determines that it is a time of special interest, the process proceeds to step 76.

At step 76, the negotiation for the exchange of telematic data is initiated by transmitting a first polling signal, including a first offer parameter, i.e., purchase offer, to the probe detectors 22 directly from the telematic base 12 or via system nodes 17. At step 78, the probe detectors polled provide an availability signal including an assent parameter if the first offer is equal to or greater than the corresponding parameter for the data polled. If the number of available probe detectors 22 is not sufficient for system calculation, the process proceeds to step 80 for increasing the value of the offer parameter by USTEP, then the process loops to step 76 for a further iteration of a polling signal and an offer parameter. If the number of available probe detectors 22 is sufficient for system operation, the process proceeds to step 82. At step 82, the system determines whether the number of available probe detectors 22 is greater than or equal to a MARGIN parameter representing the minimum number of probe detectors necessary to produce reliable traffic information. If the number is greater than MARGIN, the process proceeds to step 84 for decreasing the value of the offer parameter by DSTEP; then the process loops to step 76 for a further iteration of a polling signal and an offer parameter, i.e., purchase offer. If the number of available probe detectors 22 is not greater than or equal to MARGIN, the process proceeds to step 92. In step 92, the system transmits a release signal to the corresponding probe detectors 22 and/or MTSO for receiving the purchased telematic data and a traffic model is constructed from the transmitted telematic data and optional point detector data. At step 90 a delay is provided to await detour data from those probe detectors 22 receiving traffic data rather than a credit. After the delay 90, in step 88, sufficient detour data is collected. If the detour information is greater than a CHANGE parameter, the process proceeds to another delay in step 94 for readjusting traffic conditions. Then, the process loops to step 76 for acquiring further telematic data. Where the detour data is not greater than or equal to the CHANGE parameter, the process loops back to step 70.

Although portions of the exemplary system are described in terms of a hardware implementation, it is contemplated that some or all of the hardware functionality may be practiced entirely in software of a data processor of the vehicle or system node. This software may be embodied in a carrier such as a magnetic or optical disk or a radio frequency audio frequency carrier wave.

It will be understood that various changes in details, materials, and arrangements of the parts which have been described and illustrated above in order to explain the nature of this invention may be made by those skilled in the art without departing from the principle and scope of the invention as recited in the following claims.

What is claimed is:

1. A system for negotiating acquisition of telematic data originating from at least one vehicle traveling along a traffic route, the system comprising:
a system node providing a first polling signal including a first offer; and
a probe detector on the at least one vehicle, collecting telematic data and responsive to the first polling signal, the probe detector comparing the first offer to a selling price of the probe detector and, only if the first offer at least equals the selling price, transmitting an availability signal, including an assent to sale of at least some of the telematic data, to the system node.

2. The system of claim 1, wherein the system node, upon receiving the availability signal of the probe detector, transmits a release signal to the probe detector in response, and the probe detector transmits at least some of the telematic data to the system node in response to the release signal.

3. The system of claim 2, wherein the system node provides a content credit to the probe detector in exchange for transmission of the telematic data from the probe detector to the system node.

4. The system of claim 3, wherein the system node transmits traffic information to the at least one vehicle in exchange for a content credit.

5. The system of claim 3, wherein the system node includes a predictive traffic model for forecasting traffic and providing a traffic forecast as traffic information to a user interface of the at least one vehicle.

6. The system of claim 1, including a telematic base exchanging telematic data with the system node and including a model for forecasting traffic based on the telematic data.

7. The system of claim 6, wherein the telematic base includes a predictive traffic model for forecasting traffic and providing a traffic forecast as traffic information to a user interface of the at least one vehicle.

8. The system of claim 1, including a point detector fixed in location along the traffic route and collecting and supplying traffic data to the system node.

9. The system of claim 1, comprising an enabling device on the at least one vehicle enabling reception of the polling signal by the probe detector only when the at least one vehicle is operating.

10. The system of claim 1, wherein, if the first offer does not at least equal the selling price, the probe detector does not transmit the availability signal and the system node transmits a second polling signal with a second offer larger than the first offer.

11. A system for negotiating acquisition of telematic data originating from a plurality of vehicles traveling along traffic routes, the system comprising:
a plurality of system nodes providing respective first polling signals including respective first offers; and
a respective probe detector on each of the plurality of vehicles, the probe detectors being responsive to the first polling signals of the system nodes within respective reception regions of the system nodes, the probe detectors comparing the first offers to respective selling prices of the probe detectors and only the probe detectors in which the first offers at least equal the selling prices transmit availability signals, including an assent to sale of at least some of the telematic data, to the system nodes sending the corresponding first polling signals.

12. The system of claim 11, wherein the system nodes, upon receiving any availability signals from respective probe detectors, transmit a release signal to at least some of the probe detectors in response and may withhold transmitting release signals.

13. The system of claim 12, wherein the system nodes, upon receiving the availability signals, if any, transmit second polling signals including second offers, different from the first offers, and the probe detectors receiving the second polling signal, compare the second offers to the respective selling prices, and only the probe detectors in which the second offers at least equal the selling prices transmit availability signals.

14. The system of claim 13, wherein the second offer is of greater value than the first offer.

15. The system of claim 13, wherein the second offer is of smaller value than the first offer.

16. The system of claim 12, including a telematic base exchanging telematic data with the system nodes and including a model for forecasting traffic based on the telematic data.

17. A method of negotiating an exchange of telematic data comprising:
providing a first polling signal from a system node to a vehicle including a probe detector and traveling on a traffic route, the first polling signal including a first offer;
comparing a selling price of the probe detector with the first offer, and
only if the first offer at least equals the selling price, transmitting an availability signal from the probe detector, and including an assent to sale of at least some of the telematic data, to the system node in response to the polling signal.

18. The method of claim 17, comprising:
receiving the availability signal at the system node; and
selectively transmitting one of a release signal and a second polling signal from the system node in response to the received availability signal, the release signal indicating acceptance of the sale of at least some of the telematic data, and the second polling signal including a second offer, different from the first offer.

19. The method of claim 18, comprising:
receiving a release signal of the system node at the probe detector; and
transmitting at least some of the telematic data from the probe detector to the system node in response to the release signal, the system node providing a content credit in exchange for the telematic data transmitted.

20. The method of claim 19, wherein the system node includes a predictive traffic model for forecasting traffic and including transmitting traffic forecast to a user interface of the vehicle in exchange for a content credit from the vehicle.
